(19) United States
(12) Patent Application Publication
(10) Pub. No.: US 2018/0367006 A1
(43) Pub. Date: Dec. 20, 2018

(54) Electric Motor

(71) Applicant: HITACHI AUTOMOTIVE SYSTEMS ENGINEERING, LTD., Hitachinaka-shi, Ibaraki (JP)

(72) Inventors: Akira FUJIWARA, Hitachinaka-shi (JP); Kenji NAKAYAMA, Hitachinaka-shi (JP); Shozo KAWASAKI, Hitachinaka-shi (JP); Hiroshi KANAZAWA, Hitachinaka-shi (JP); Masahiro HOSOYA, Hitachinaka-shi (JP)

(21) Appl. No.: 15/779,229

(22) PCT Filed: Nov. 18, 2016
(86) PCT No.: PCT/JP2016/084188

§ 371 Date: May 25, 2018

(30) Foreign Application Priority Data
Nov. 26, 2015 (JP) 2015-230177

(51) Int. Cl. H02K 3/38; H02K 3/18; H02K 3/50

(52) U.S. Cl. CPC H02K 3/38; H02K 3/50; H02K 3/18

(57) ABSTRACT

The present invention provides a novel electric motor that allows improvement in the electrical insulation performance of the winding wire on the innermost peripheral side between adjacent teeth. A winding wire is wound in three layers around a tooth. The winding wire in a first winding layer is wound from a core back to a collar portion, and the winding wire in a second winding layer is wound from the collar portion to the core back. The start end of the winding wire in the first winding layer wound around a tooth is arranged on the core back side of the second winding layer. The terminal end and its vicinity of the winding wire in the first winding layer is arranged on the collar portion side of the first winding layer to leave a second winding layer start end arrangement space where the start end of the winding wire in the second winding layer is to be arranged. The start end of the winding wire in the second winding layer is arranged in the second winding layer start end arrangement space on the collar portion side of the first winding layer. The terminal end of the second winding layer is arranged on the core back side.

### TECHNICAL FIELD

The present invention relates to an electric motor, in particular to an electric motor in which a winding wire is wound around split cores.

### BACKGROUND ART

In general, a brushless electric motor including a rotor with a permanent magnet and a stator around which an electromagnetic winding wire is wound can be increasingly enhanced in performance with a higher density (space factor) of the winding wire wound around the teeth of the stator. For example, JP 2014-166102 A (PTL 1) describes that an electromagnetic winding wire is formed by winding a rectangular wire in multiple layers in such a manner as to leave a space of one rectangular wire.

According to PTL 1, the electromagnetic winding wire is formed by winding the rectangular wire in multiple layers such that the rectangular wire in odd-numbered layers is wound from a core back to a collar portion and the rectangular wire in even-numbered layers is wound from the collar portion to the core back, and that when the positions in the slots of the individual layers at which to start winding the rectangular wire are deemed as winding start positions and the positions in the individual layers axisymmetric to the winding start positions with respect to a winding drum are deemed as winding end positions, a vacant space of one rectangular wire is left at the winding end positions in the odd-numbered layers.

### CITATION LIST

### Patent Literature

PTL 1: JP 2014-166102 A

### SUMMARY OF INVENTION

### Technical Problem

PTL 1 describes that the rectangular wire is wound in multiple layers to increase the density of the winding wire wound around the teeth of the stator such that when the positions in the slots of the individual layers at which to start winding the rectangular wire are deemed as winding start positions and the positions in the individual layers axisymmetric to the winding start positions with respect to the winding drum are deemed as winding end positions, a vacant space of one rectangular wire is left at the winding end positions in the odd-numbered layers.

In a stator with a round electromagnetic winding wire as well as the one with a rectangular electromagnetic winding wire, the cross sections (slots) between the teeth of the stator are fan-shaped, and winding the wire with an increased density would cause the winding wire on the inner peripheral side of one tooth to come close to the winding wire on the adjacent tooth. This makes it difficult to keep a favorable electrical insulation condition. For example, if the adjacent winding wires between the teeth contact and rub against each other due to vibration, the insulation coating film of the winding wire may get damaged and short-circuited. The foregoing issues will be described later in detail.

An object of the present invention is to provide a novel electric motor that allows improvement in the electrical insulation performance of the winding wire on the inner peripheral side between adjacent teeth.

### Solution to Problem

The present invention is characterized in that a winding wire is wound in at least three layers around teeth, the winding wire in a first winding layer is wound from a core back to a collar portion, the winding wire in a second winding layer is wound on the first winding layer from the collar portion to the core back, a start end of the winding wire in the first winding layer wound around the tooth is arranged on a core back side of the second winding layer, a terminal end and its vicinity of the winding wire in the first winding layer is arranged on a collar portion side of the first winding layer to leave a second winding layer start end arrangement space where a start end of the winding wire in the second winding layer is to be arranged, the start end of the winding wire in the second winding layer is arranged in the second winding layer start end arrangement space on the collar portion side of the first winding layer, and a terminal end of the winding wire in the second winding layer is arranged on the core back side.

### Advantageous Effects of Invention

According to the present invention, it is possible to provide an insulation space of one winding wire between the winding wires wound on the inner peripheral side of the adjacent teeth, thereby to lengthen the distance between the winding wires and improve electrical insulation performance.

### BRIEF DESCRIPTION OF DRAWINGS

FIG. 1 is a cross-sectional view of a configuration of an electric motor to which the present invention is applied.

FIG. 2 is a perspective view of a rotor and a stator of the electric motor illustrated in FIG. 1.

FIG. 3 is a cross-sectional diagram describing a structure of a tooth and a winding wire according to an embodiment of the present invention.

FIG. 4 is a cross-sectional diagram describing the relationship between the adjacent teeth and the winding wire illustrated in FIG. 3.

FIG. 5 is a cross-sectional view of a configuration in which a start end of the winding wire in a first layer is determined at a position in a second layer.

FIG. 6 is a cross-sectional diagram describing a configuration of a modification example of FIG. 5.

FIG. 7 is a cross-sectional diagram describing a conventional winding structure of a tooth and a winding wire.

FIG. 8 is a cross-sectional diagram describing the conventional relationship between adjacent teeth and a winding wire.

### DESCRIPTION OF EMBODIMENTS

An embodiment of the present invention will be described below in detail with reference to the drawings. However, the present invention is not limited to the following embodiment but various modification examples and application examples fall within the scope of the technical concept of the present invention.

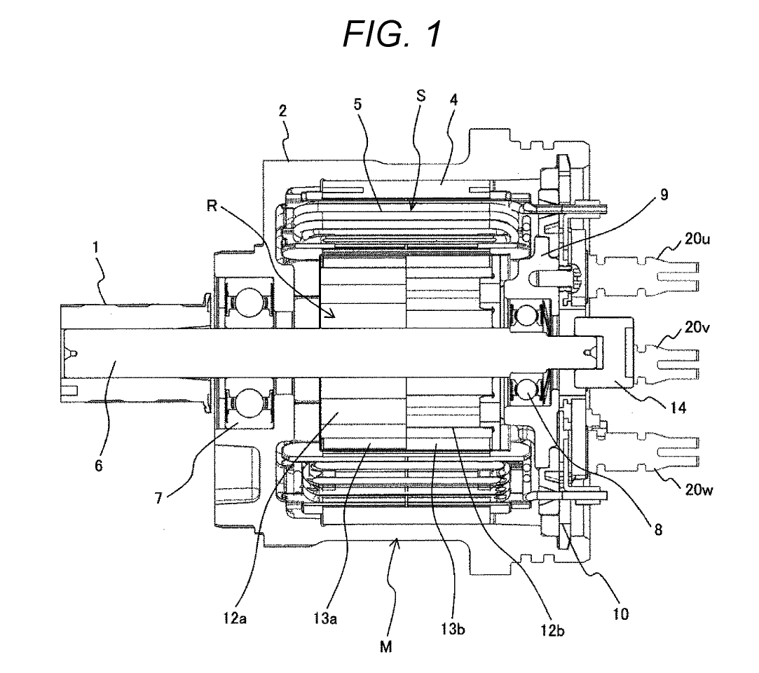

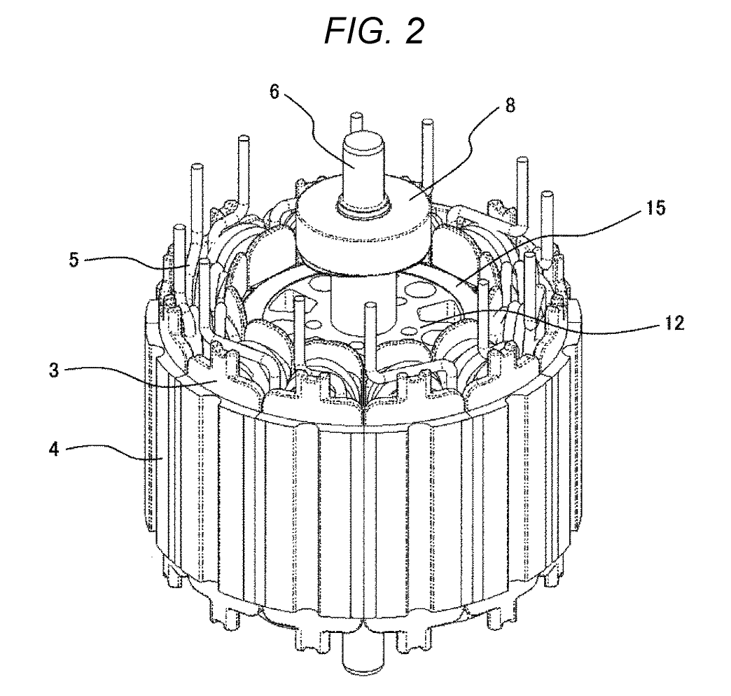

Before description of the embodiment of the present invention, a configuration of an electric motor to which the present invention is applied will be briefly explained with reference to FIGS. 1 and 2. After that, descriptions will be given as to a configuration of a conventional winding structure of teeth and a winding wire and a configuration of a winding structure of teeth and a winding wire according to the embodiment.

FIG. 1 illustrates a configuration of an electric motor in an electro-mechanical power steering apparatus in which the electric motor and a control device are integrated. FIG. 2 illustrates a configuration of a stator and a rotor in the electric motor.

With reference to FIGS. 1 and 2, an electric motor M basically includes a stator S and a rotor R stored in a housing 2. The electric motor M has a pulley 1 fixed to an output shaft 6 constituting the rotor R to drive the gear in the power steering apparatus via a belt not illustrated.

A control device not illustrated is arranged on the right side of FIG. 1 to supply power to the electric motor M. The power from the control device to the electric motor M is supplied to a winding wire in the electric motor M via three-phase terminals 20u, 20v, and 20w on the electric motor M. The electric motor M also has a magnetic pole sensor magnet 14 at an end of the output shaft 6 of the rotor R (opposite to the pulley 1) to detect the magnetic pole position of the rotor R.

In correspondence to the magnetic pole sensor magnet 14, the control device has a detector formed from a GMR sensor element. The magnetic sensor can detect the magnetic pole position of the rotor R by the magnetic pole sensor magnet 14 and the GMR sensor element.

The rotor R has the output shaft 6 arranged in the center. A front rotor core 12 and a rear rotor core 13 are fixed to the output shaft 6. Each of the rotor cores 12 and has a front permanent magnet 13a and a rear permanent magnet 13b. The outer peripheries of the magnets are covered with a magnet cover.

One end of the output shaft 6 of the rotor R is supported by a front bearing 7 fixed to the housing 2. The outer end of the output shaft 6 is supported by a rear bearing fixed to a bearing case 9 attached to the housing 2. The bearing case 9 is attached to the housing 2 by a bevel-type retaining ring 10.

The housing 2 contains a winding wire 5 wound around stator cores 4. The winding wire 5 is formed from a three-phase winding wire. The input end of the winding wire 5 is electrically connected to the three-phase terminals 20u, 20v, and 20w.

As illustrated in FIG. 2, the stator cores 4 are arranged on the outermost periphery of the stator S. The stator cores 4 are T-shaped split cores with a concentrated winding structure in which one phase of the winding wire 5 is wound around two adjacent teeth in a concentrated manner. Each of the stator cores 4 has a circumferentially extending core back and is fixed by welding on the outer periphery of the core back to the housing 2 or shrink fitting to the housing 2.

One stator core 4 (unit stator core) includes a collar portion on the inner peripheral side and the core back on the outer peripheral side. The collar portion and the core back are connected by the tooth. A synthetic resin bobbin 3 is provided between the outer peripheral surface of the tooth and the inner peripheral surface of the core back so that the winding wire 5 and the stator core 4 are electrically insulated from each other.

The thus configured electric motor is already well known and further descriptions thereof will be omitted.

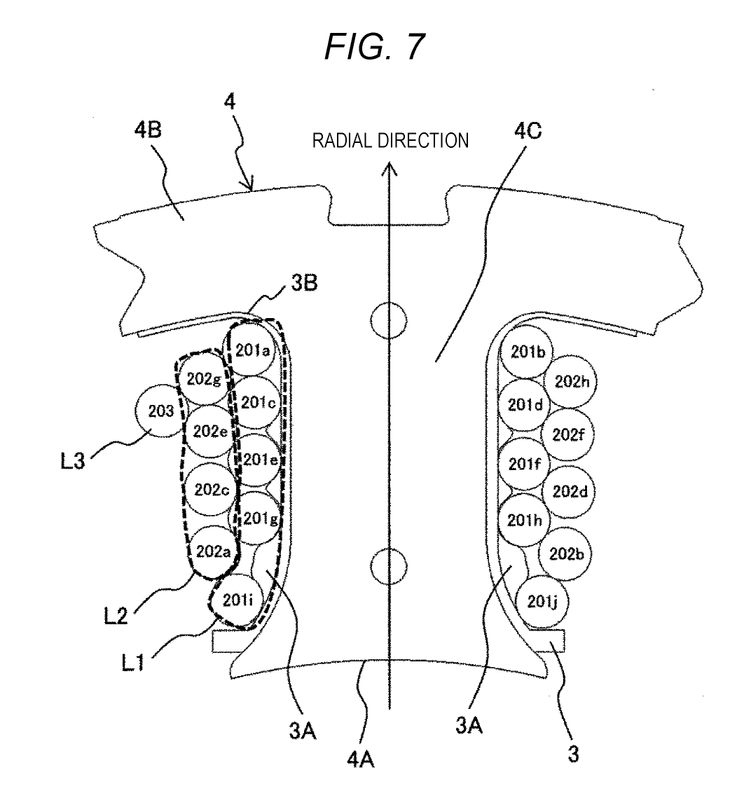

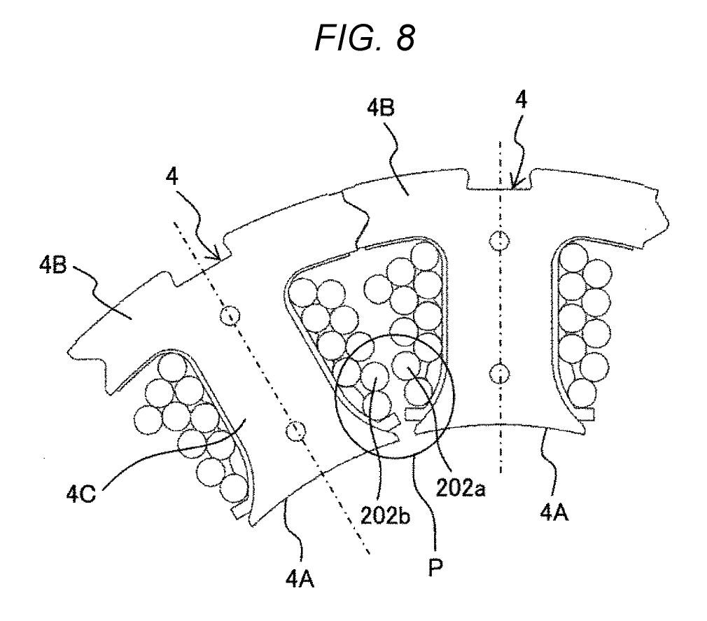

As described above, the cross sections (slots) between the teeth of the stator cores are fan-shaped, and winding the wire with an increased density would cause the winding wire on the inner peripheral side of one tooth to come close to the winding wire on the adjacent tooth, thereby making it difficult to keep a favorable electrical insulation condition. The foregoing issue will be described with reference to FIGS. 7 and 8.

With reference to FIG. 7, the unit stator core 4 has a collar portion 4A on the inner peripheral side and a core back 4B on the outer peripheral side. The collar portion 4A is shaped along the circumferential direction. A tooth 4C is formed between the collar portion 4A and the core back 4B. Its entire cross section is T-shaped. The synthetic resin bobbin 3 is provided on the outer peripheral surface of the tooth 4C and the inner surface of the core back 4B connected to the tooth 4C. The bobbin 3 has a function to provide electrical insulation between the unit stator core 4 and the winding wire as already known.

The winding wire is wound around the outer periphery of the bobbin 3 in a plurality of layers. In the configuration of FIG. 7, the winding wire is wound in at least three layers. A first winding layer L1 is wound from the core back 4B side toward the collar portion 4A side in close contact with the surface of the bobbin 3. Therefore, a start end 201a of the first winding layer L1 is positioned in a connection area of the tooth 4C and the core back 4B in the first winding layer L1 as seen from the layering direction of the winding wire.

The winding wire in the first winding layer L1 starts to be wound from the start end 201a in the order of 201b, 201c, 201d, 201e, 201f, 201g, 201h, 201i and 201j. The bobbin 3 has protrusions 3A formed in proximity to the collar portion 4A between the winding wires 201g and 201i and between the wining wires 201h and 201i. The protrusions 3A have a function to prevent the winding wires 201i and 201j from moving toward the winding wires 201g and 201h. Therefore, a start end of a second winding layer L2 can be reliably arranged in the spaces formed by the protrusions 3A.

The second winding layer L2 is wound and laid on the first winding layer L1 from the collar portion 4A side toward the core back 4B side. Therefore, a start end 202a of the second winding layer L2 is positioned in an area in proximity to the collar portion 4A. The winding wire in the second winding layer L2 starts to be wound from the start end 202a near the protrusion 3A, and then wound and laid on the first winding layer L1 in the order of 202b, 202c, 202d, 202e, 202f, 202g, and 202h. Then, a terminal end 202h of the winding layer in the second winding layer L2 is wound and laid on the second winding layer L2 to form a third winding layer L3. A terminal end 203 of the third winding layer L3 is pulled out of the stator core 4.

In this manner, the start end of the winding wire 201a in the first winding layer L1 is positioned in a connection area portion 3B between the tooth 4C and the core back 4B in the first winding layer L1. Accordingly, the start end 202a of the second winding layer L2 starts to be wound from a position near the protrusion 3A in an area in proximity to the collar portion 4A, and is wound and laid on the first winding layer L1 toward the core back 4B side.

Therefore, as illustrated in part P of FIG. 8, the winding wire 202a and winding wire 202b in the adjacent second winding layers L2 on the inner peripheral side of the teeth 4C come close to each other, which makes it difficult to keep a favorable electrical insulation condition.

Accordingly, an embodiment of the present invention suggests a structure in which a favorable electrical insulation condition can be kept between the winding wire 202a and winding wire 202b in the adjacent second winding layers L2 on the inner peripheral side of the teeth 4C.

In the embodiment, the start end of the winding wire in the first winding layer wound around the tooth is arranged on the core back side of the second winding layer, the terminal end and its vicinity of the winding wire in the first winding layer is positioned on the collar portion side of the first winding layer to leave the second winding layer start end arrangement space where the start end of the winding wire in the second winding layer is to be arranged, the start end of the winding wire in the second winding layer is arranged in the second winding layer start end arrangement space on the collar portion side of the first winding layer, and the terminal end of the second winding layer is arranged on the core back side.

According to this configuration, it is possible to provide an insulation space of one winding wire between the winding wires wound on the inner peripheral side of the adjacent teeth, thereby to lengthen the distance between the winding wires and improve electrical insulation performance.

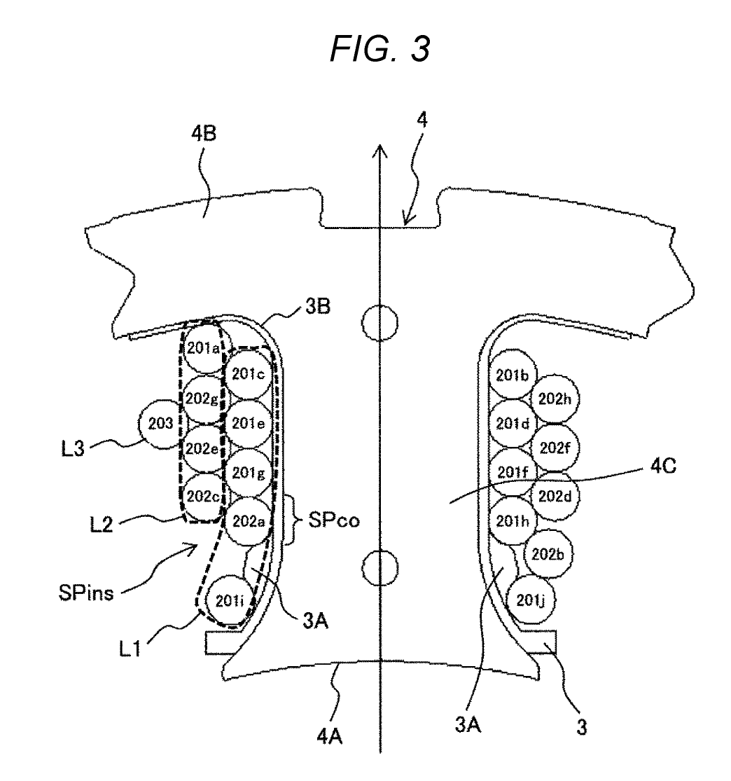

An embodiment of the present invention will be described later in detail with reference to FIGS. 3 to 6. The same reference signs as those shown in FIGS. 7 and 8 denote components or constituent elements having identical or similar functions. Accordingly, duplicated descriptions thereof may be omitted when they are not necessary. The stator cores 4 used in the embodiment are split cores and the electromagnetic winding wire is formed by winding the winding wire around the teeth 4C of the stator cores 4 in a concentrated manner.

Each of the stator cores 4 has the bobbin 3 axially inserted therein. The winding wire is wound around the tooth 4C via the bobbin 3 in a concentrated manner. The winding wire arranged nearest the tooth 4C is defined as first winding layer L1, the winding wire outside the first winding layer L1 is defined as second winding layer L2, and the winding wire further outside the second winding layer L2 is defined as third winding layer (final winding layer) L3.

As with the configuration illustrated in FIG. 7, the first winding layer L1 is wound from the core back 4B side toward the collar portion 4A side. The first winding layer L1 is wound in close contact with the surface of the bobbin 3. As seen from the layering direction of the winding wire, the start end 201a of the first winding layer L1 is positioned in the connection area portion 3B between the tooth 4C and the core back 4B in the second winding layer L2.

The winding wire in the first winding layer L1 is wound around the bobbin 3 from the start end 201a positioned in the second winding layer L2 as seen from the layering direction of the winding wire, then wound as winding wire 201b positioned in the first winding layer L1 as seen from the layering direction, and then wound in the order of 201c, 201d, 201e, 201f, 201g, and 201h. The winding wire 201h goes across the protrusion 3A and is further wound between the collar portion 4A and the protrusion 3A. Then, the winding wire is wound from 201i to 201j. The winding wire 201j constitutes the terminal end of the first winding layer L1.

It is important here that the winding wire in the first winding layer L1 is not wound between the winding wire 201g and the protrusion 3A, thereby to leave a second winding layer start end arrangement space SPco where the start end 202a of the second winding layer L2 is to be arranged.

Therefore, the terminal end 201j of the first winding layer L1 forms subsequently the second winding layer L2. As described above, the start end of the second winding layer L2 is wound and arranged in the second winding layer start end arrangement space SPco where the first winding layer L1 exists.

The second winding layer L2 is wound from the collar portion 4A side toward the core back 4B side and laid on the first winding layer L1. Therefore, the start end 202a of the second winding layer L2 is arranged in an area in proximity to the collar portion 4A at a position where the first winding layer L1 exists. In this manner, the winding layer in the second winding layer L2 starts to be wound from the start end 202a in the second winding layer start end arrangement space SPco, and wound and laid on the first winding layer L1 in the order of 202b, 202c, 202d, 202e, 202f, 202g, and 202h. Then, the terminal end 202h of the winding wire in the second winding layer L2 is wound and laid on the second winding layer L2, and then the winding wire 203 in the third winding layer L3 is pulled out of the stator core 4.

In this manner, the start end of the winding wire 201a in the first winding layer L1 is positioned in the connection area portion 3B between the tooth 4C and the core back 4B in the second winding layer L2. Thus, the start end 202a of the second winding layer L2 is arranged in the second winding layer start end arrangement space SPco in the first winding layer L1 in proximity to the collar portion 4A. Accordingly, the start end 202a of the winding wire in the second winding layer L2 is shifted to the first winding layer L1, whereby the space in which the start end 202a of the winding wire in the second winding layer L2 has been located so far is left as an insulation space SPins of one winding wire.

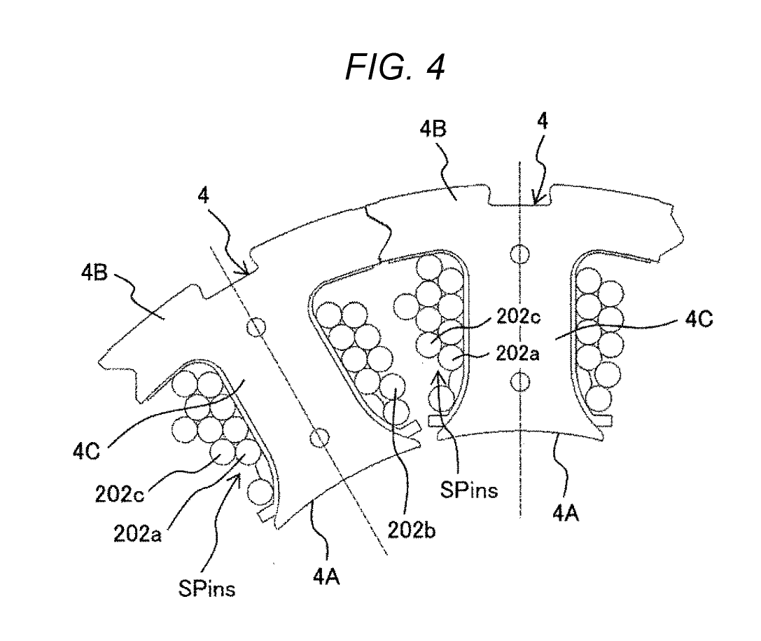

Therefore, as illustrated in FIG. 4, the insulation space SPins widens the clearance between the winding wire 202a and the winding wire 202b in the adjacent second winding layers L2 on the inner peripheral side of the teeth 4C to improve electrical insulation performance.

Next, descriptions will be given as to a configuration of a holding mechanism by which to hold the start end 201a of the winding wire in the first winding layer L1 at a position in the second winding layer L2.

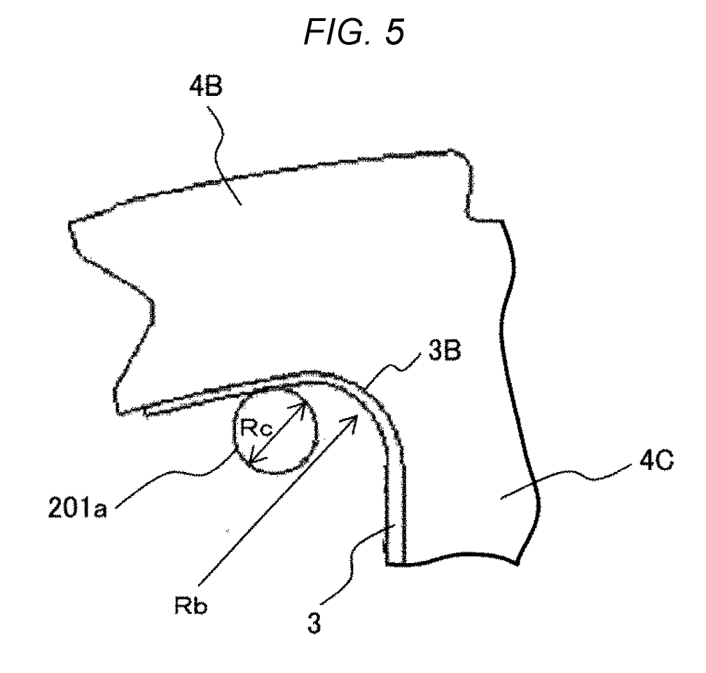

FIG. 5 illustrates a partial cross section of the connection area between the core back 4B and the tooth 4C for describing a first holding mechanism. As illustrated in FIG. 5, tensile force acts on the winding wire in the first winding layer L1 on the tooth 4C side due to a winding operation. Therefore, when the radius of the connection area portion 3B of the bobbin 3 in the connection area between the core back 4B and the tooth 4C is small, the start end 201a of the winding wire in the first winding layer L1 comes close to the tooth 4C and comes into such a winding state as illustrated in FIG. 7.

In contrast to this, when the radius of the connection area portion 3B of the bobbin 3 in the connection area between the core back 4B and the tooth 4C is large, the start end 201a of the winding wire in the first winding layer L1 is kept from coming close to the tooth 4C and comes into such a winding state as illustrated in FIG. 3. In the embodiment, desirably, a radius Rb of the connection area portion 3B of the bobbin 3 is set to be larger than a radius Rc of the start end 201a of the winding wire in the first winding layer L1.

This makes it possible to hold the start end 201a of the winding wire in the first winding layer L1 at a position in the second winding layer L2. According to this configuration, there is no need to attach an additional component to the bobbin 3, which is effective in simplifying the structure of the bobbin 3.

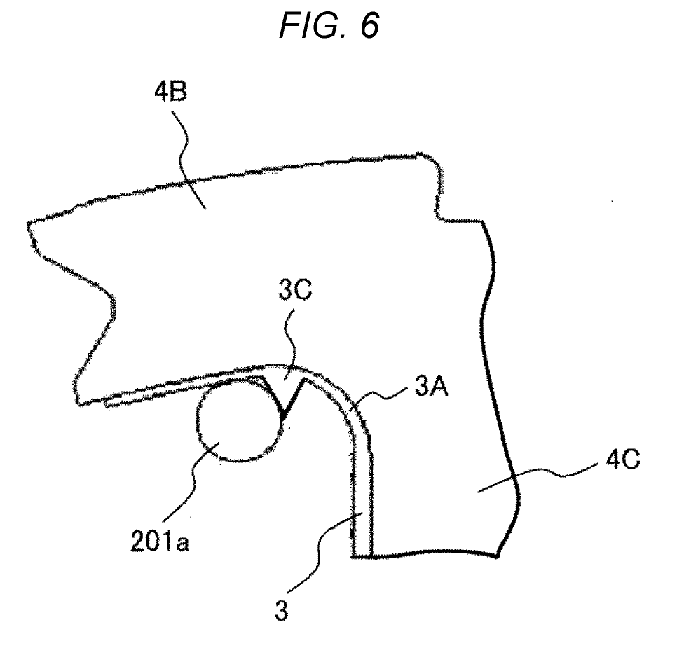

FIG. 6 illustrates a partial cross section of the connection area between the core back 4B and the tooth 4C for describing a second holding mechanism. As illustrated in FIG. 6, a positioning projection 3C is formed in the connection area 3B of the bobbin 3 in the connection area between the core back 4B and the tooth 4C. The positioning projection 3C has a function to receive the start end 201a of the winding wire in the first winding layer L1 so that the start end 201a of the winding wire is positioned on the positioning projection 3C.

Accordingly, it is possible to keep the start end 201a of the winding wire in the first winding layer L1 from coming close to the tooth 4C side and achieve such a winding state as illustrated in FIG. 3. This configuration is effective in determining reliably the position of the start end 201a of the winding wire in the first winding layer L1.

As described above, the present invention is configured such that the winding wire is wound in at least three layers around the teeth, the winding wire in the first winding layer is wound from the core back to the collar portion, the winding wire in the second winding layer is wound from the collar portion to the core back, the start end of the winding wire in the first winding layer wound around the teeth is arranged on the core back side of the second winding layer, the terminal end and its vicinity of the winding wire in the first winding layer is arranged on the collar portion side of the first winding layer to leave the second winding layer start end arrangement space where the start end of the winding wire in the second winding layer is to be arranged, the start end of the winding wire in the second winding layer is arranged in the second winding layer start end arrangement space on the collar portion side of the first winding layer, and the terminal end of the winding wire in the second winding layer is arranged on the core back side.

According to the present invention, it is possible to provide an insulation space of one winding wire between the winding wires wound on the inner peripheral side of the adjacent teeth, thereby to lengthen the distance between the winding wires and improve electrical insulation performance.

The present invention is not limited to the foregoing embodiment but includes various modification examples. For example, the foregoing embodiment is described in detail for easy comprehension of the present invention and is not necessarily limited to the one including all the components described above. In addition, some of components of an example can be replaced with components of another example, and components of an example can be added to components of another example.

### REFERENCE SIGNS LIST

1 Pulley
2 Housing
3 Bobbin
3A Protrusion
3B Connection area portion
3C Positioning projection
4 Stator core
4A Collar portion
4B Core back
4C Teeth
5 Winding wire
6 Output shaft
7 Front bearing
8 Rear bearing
9 Bearing case
10 Bevel-type retaining ring
12 Rotor core
12a Front rotor core
12b Rear rotor core
13a Front permanent magnet
13b Rear permanent magnet
14 Permanent magnet of magnetic pole sensor
20u2, 20v, 20w Three-phase terminal
201a to 201j Winding wire in first winding layer
202a to 202g Winding wire in second winding layer
203 Winding wire in third winding layer
L1 First winding layer
L2 Second winding layer
L3 Third winding layer
SPco Second winding layer start end arrangement space
SPins Insulation space

1. An electric motor comprising:
a core back that extends along a circumferential direction;
a tooth that is formed radially from the core back to an inner peripheral side; and
a collar portion that is formed from a leading end of the tooth along the circumferential direction, an electromagnetic winding wire being formed by winding a winding wire in multiple layers around a slot surrounded by the core back, the tooth, and the collar portion, wherein
a winding wire is wound in at least three layers around teeth,
the winding wire in a first winding layer is wound from the core back to the collar portion,
the winding wire in a second winding layer is wound on the first winding layer from the collar portion to the core back,
a start end of the winding wire in the first winding layer wound around the tooth is arranged on the core back side of the second winding layer,
a terminal end and a vicinity of the terminal end of the winding wire in the first winding layer is arranged on the collar portion side of the first winding layer to leave a second winding layer start end arrangement space where a start end of the winding wire in the second winding layer is to be arranged,
the start end of the winding wire in the second winding layer is arranged in the second winding layer start end arrangement space on the collar portion side of the first winding layer, and
a terminal end of the winding wire in the second winding layer is arranged on the core back side.

2. The electric motor according to claim 1, wherein
a synthetic resin bobbin is provided on an outer peripheral surface of the tooth and an inner surface of the core back, and
a radius Rb of a connection area portion of the bobbin between the tooth and the core back is set to be larger than a radius of the winding wire.

3. The electric motor according to claim 1, wherein
a synthetic resin bobbin is provided on an outer peripheral surface of the tooth and an inner surface of the core back, and
a positioning projection is formed to determine the position of a start end of the winding wire in the first winding layer in part of a connection area portion of the bobbin between the tooth and the core back.
